(19) United States
(12) Patent Application Publication
(10) Pub. No.: US 2008/0319697 A1
(43) Pub. Date: Dec. 25, 2008

(54) SYSTEM AND METHOD FOR DETERMINING AN AMOUNT OF PRESSURE APPLIED BY AN OCCUPANT ON A VEHICLE SEAT

(76) Inventors: Charles A. Gray, Noblesville, IN (US); Mark C. Hansen, Kokomo, IN (US); Brett A. Hall, Kokomo, IN (US); Patrick D. Langley, Kokomo, IN (US); Paul E. Lucas, Brighton, MI (US)

Correspondence Address: DELPHI TECHNOLOGIES, INC., M/C 480-410-202, PO BOX 5052, TROY, MI, 48007, US

(21) Appl. No.: 11/765,175

(22) Filed: Jun. 19, 2007

(51) Int. Cl. G01L 27/00

(52) U.S. Cl. 702/98

(57) ABSTRACT

A system and a method for determining an amount of pressure applied by an occupant on a vehicle seat are provided. The method includes receiving signals from a pressure transducer, a temperature sensor, and a belt tension sensor. The method further includes determining a compensated pressure value indicative of the amount of pressure applied to the vehicle seat based on the signals from the pressure transducer, the temperature sensor, and the belt tension sensor.

### BACKGROUND

A vehicle system has been developed that monitors a pressure on a vehicle seat to determine whether a passenger on the vehicle seat is an adult or a child.

A drawback associated with the existing vehicle system is that the system may not be able to determine a pressure exerted on the vehicle seat by a passenger as accurately as desired since the measured pressure is not compensated for temperature, an applied seat belt tension, vehicle seat aging, and vehicle seat compression.

Accordingly, the inventors herein have recognized a need for a system and a method that accurately determines a pressure exerted on a vehicle seat by a passenger, compensating for temperature, an applied seat belt tension, vehicle seat aging and vehicle seat compression.

### SUMMARY OF THE INVENTION

A method for determining an amount of pressure applied by an occupant on a vehicle seat in a vehicle in accordance with an exemplary embodiment is provided. The method includes receiving a first signal from a pressure transducer in the vehicle seat at a microprocessor. The first signal is indicative of a pressure measured by the pressure transducer. The method further includes determining a pressure value based on the first signal, utilizing the microprocessor. The method further includes receiving a second signal from a temperature sensor at the microprocessor. The second signal indicates a temperature proximate the vehicle seat. The method further includes determining a temperature value based on the second signal, utilizing the microprocessor. The method further includes receiving a third signal from a belt tension sensor at the microprocessor. The third signal indicates an amount of tension on a seat belt associated with die vehicle seat. The method further includes determining a belt tension value based on the third signal, utilizing the microprocessor. The method further includes determining a compensated pressure value indicative of the amount of pressure applied to the vehicle seat based on the pressure value, the temperature value, and the belt tension value, utilizing the microprocessor. The method further includes storing the compensated pressure value indicative of the amount of pressure applied to the vehicle seat in a memory device, utilizing the microprocessor. The method may additionally include determining a classification of the occupant based on the amount of pressure applied to the vehicle seat.

A system for determining an amount of pressure applied by an occupant on a vehicle seat in a vehicle in accordance with another exemplary embodiment is provided. The system includes a pressure transducer disposed in the vehicle seat. The pressure transducer is configured to generate a first signal indicative of a pressure measured by the pressure transducer. The system further includes a temperature sensor disposed proximate the vehicle seat. The temperature sensor is configured to generate a second signal indicating a temperature proximate the vehicle seat. The system further includes a belt tension sensor coupled to a seat belt associated with the vehicle seat. The belt tension sensor is configured to generate a third signal indicating an amount of tension applied to a seat belt associated with the vehicle seat. The system further includes a microprocessor operably communicating with the pressure transducer and the temperature sensor and the belt tension sensor. The microprocessor is configured to determine a pressure value based on the first signal. The microprocessor is further configured to determine a temperature value based on the second signal. The microprocessor is further configured to determine a belt tension value based or; the third signal. The microprocessor is further configured to determine a compensated pressure value indicative of the amount of pressure applied to the vehicle seat based on the pressure value, the temperature value, and the belt tension value. The microprocessor is further configured to store the compensated pressure value indicative of the amount of pressure applied to the vehicle seat in a memory device. The microprocessor may be additionally configured to determine a classification of the occupant based on the amount of pressure applied to the vehicle seat.

### BRIEF DESCRIPTION OF THE DRAWINGS

FIG. 1 is a schematic of a vehicle having a system for determining an amount of pressure applied by an occupant on a vehicle seat in accordance with an exemplary embodiment;

FIGS. 2-3 are flowcharts of a method for determining an amount of pressure applied by an occupant on a vehicle seat in accordance with another exemplary embodiment;

FIG. 4 is a graph of time-based seat aging compensation values utilized by the system of FIG. 1;

FIG. 5 is a graph of condition-based seat aging compensation values utilized by the system of FIG. 1; and

FIG. 6 is a graph of compression compensation values utilised by the system of FIG. 1.

### DESCRIPTION OF EXEMPLARY EMBODIMENTS

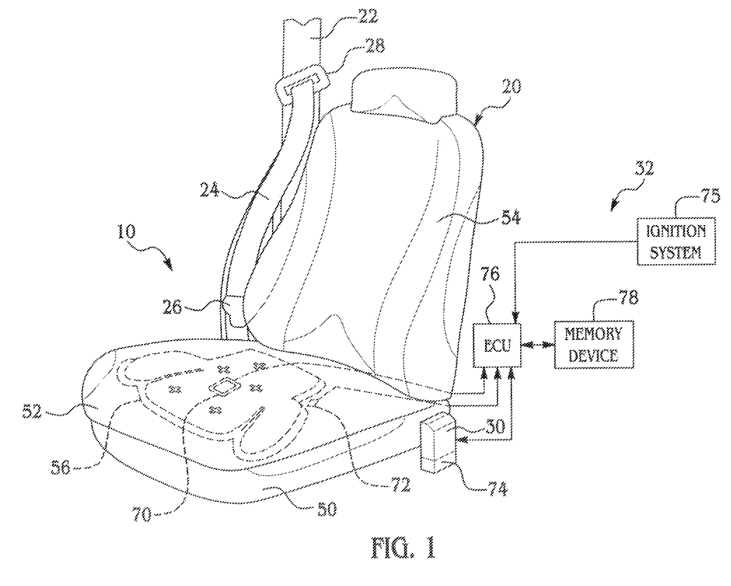

Referring to FIG. 1, a vehicle 10 having a seat 20 is illustrated. The vehicle 10 further includes a B-pillar 22, a belt 24, a clip 26, an anchor 28, a buckle 30, and a system 32 for determining an amount of pressure applied by an occupant on the vehicle seat 20. An advantage of the system 32 is that the system 32 can more accurately determine an amount of pressure applied by an occupant on the vehicle seat 10 than other systems. As a result, the system 32 can more accurately classify the occupant as either an adult occupant or a child occupant as compared to other systems.

The vehicle seat 20 is provided to hold a vehicle occupant thereon. The seat 20 includes a frame 50, foam cushions 52, 54 and a bladder 56. The frame 50 is fixedly coupled to a portion of a vehicle frame (not shown). The foam cushions 52, 54 are disposed on the frame 50. Further, in one exemplary embodiment the bladder 56 is disposed under the foam cushion 52. In an alternative exemplary embodiment, the bladder 56 is disposed in the foam cushion 52. The bladder 56 includes a fluid such as silicon for example, which is non-corrosive, and not subject to freezing at extreme ambient temperatures. In addition, a semi-rigid backplane may be placed under the bladder 56 to provide a suitable reaction surface, as disclosed for example in U.S. Pat. No. 6,490,936, filed May 14, 1999, assigned to the assignee of the present invention and incorporated herein by reference. Alternatively, the bladder 56 may be placed between two semi rigid backplanes to provide reaction services on both sides of the bladder 56.

The system 32 is provided to determine an amount of pressure applied by occupant on the vehicle seat 20. Further, the system 32 is provided to determine a seat occupant classification based upon the amount of pressure applied by the occupant on the vehicle seat 20. The system 32 includes a pressure transducer 70, a temperature sensor 72, a belt tension sensor 74, an ignition system 75, a microprocessor 76, and a memory device 78.

The pressure transducer 70 is configured to generate a signal indicative of an amount of pressure in the bladder 56, that is received by the microprocessor 76. The pressure transducer 70 is operably coupled to the bladder 56 and is electrically coupled to the microprocessor 76.

The temperature sensor 72 is configured to generate a signal indicative of a temperature level proximate the seat 20, that is received by the microprocessor 76. In one exemplary embodiment, the temperature sensor 72 is disposed within the foam cushion 52 and is electrically coupled to the microprocessor 76. Of course, the temperature sensor 72 could be disposed in alternate locations outside of the vehicle seat 20.

The belt tension sensor 74 is configured to generate a signal indicative of an amount of tension applied to the seat belt 24 by an occupant, that is received by the microprocessor 76. In one exemplary embodiment, the belt tension sensor 74 is disposed on the buckle 30 associated with the vehicle seat 20. As shown, the belt extends through an anchor member 28 and has a clip 26 configured to be received by the buckle 34 for securing an occupant in the vehicle seat 20.

The ignition system 75 is provided to activate an engine (not shown) of the vehicle 10. During operation, the ignition system 75 is configured to generate a signal indicating activation of the engine that is received by the microprocessor 76.

The microprocessor 76 is configured to determine an amount of pressure applied by an occupant on the vehicle seat 20 in response to signals received from the pressure transducer 70, the temperature sensor 72, the belt tension sensor 74, and the ignition system 75, as will be described in greater detail below. Further, the microprocessor 76 is configured to determine a seat occupant classification based upon the amount of pressure applied by the occupant on the vehicle seat 20, as will be described in greater detail below.

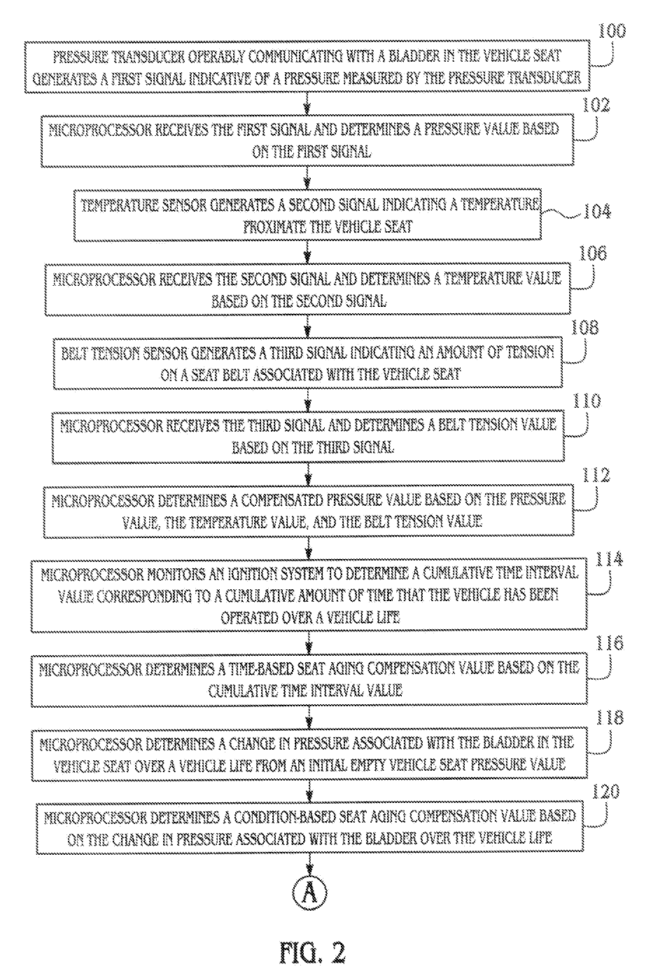

Referring to FIGS. 2-4, a flowchart of a method for determining an amount of pressure applied by an occupant on die vehicle seat 20, utilizing the system 32, will now be explained.

At step 100, the pressure transducer 70 operably communicating with the bladder 56 in the vehicle seat 20 generates a first signal indicative of a pressure measured by the pressure transducer 70.

At step 102, the microprocessor 76 receives the first signal and determines a pressure value based on the first signal.

At step 104, the temperature sensor 72 generates a second signal indicating a temperature proximate the vehicle seat 20.

At step 106, the microprocessor 76 receives the second signal and determines a temperature value based on the second signal.

At step 108, the belt tension sensor 74 generates a third signal indicating an amount, of tension on the seat belt 24 associated with the vehicle seat 20.

At step 110, the microprocessor 76 receives the third signal and determines a belt tension value based on the third signal.

At step 112, the microprocessor 76 determines a compensated pressure value based on the pressure value, the temperature value, and the belt tension value. In particular, the microprocessor can determine the compensated pressure value utilizing the following equation:

Compensated pressure value=F(pressure value,temperature value,belt tension value), wherein the term F corresponds to a mathematical function.

At step 114, the microprocessor 76 monitors the ignition system 75 to determine a cumulative time interval value corresponding to a cumulative amount of time that the vehicle 10 has been operated over a vehicle life.

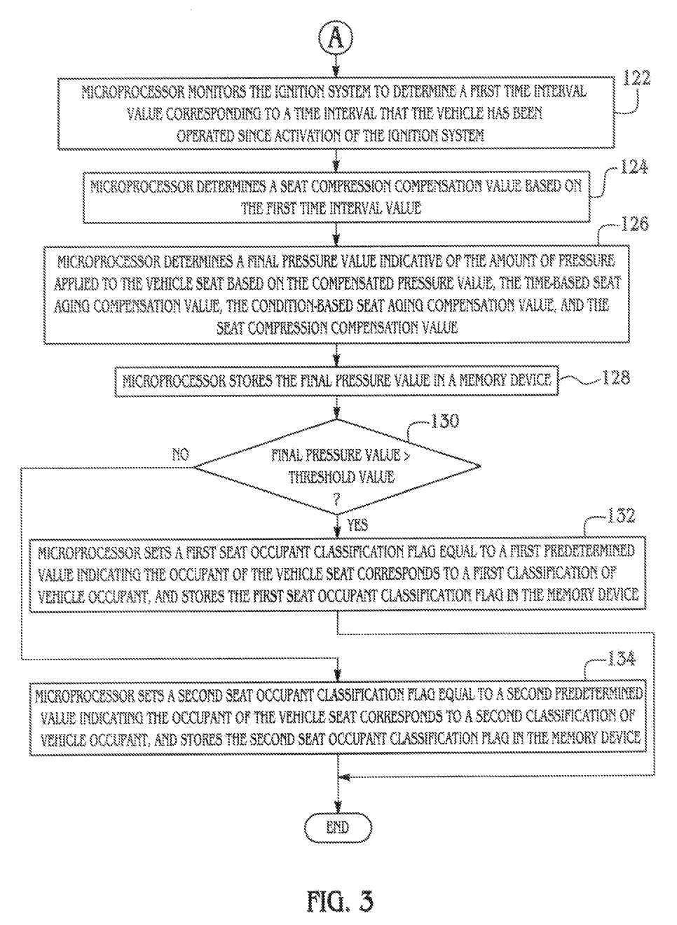

At step 116, the microprocessor 76 determines a time-based seat aging compensation value based on the cumulative time interval value. Referring to FIG. 4, for example, the memory device 78 can store a first table having a plurality of values corresponding to the graph 149. The graph 149 has a y-axis corresponding to a time-based seat aging compensation values and an x-axis corresponding to associated cumulative time interval values. The curve 150 represents a plurality of time-based scat aging compensation values. In particular, during operation, the microprocessor 76 can access the first table stored in the memory device 78 corresponding to the graph 149 to retrieve a time-based seat aging compensation value associated with a calculated cumulative time interval value. For example, if the cumulative time interval value determined by the microprocessor 76 is equal to 250 hours, the microprocessor 76 could retrieve a time-based seat aging compensation value of −0.05 PSI from the first table.

Referring again to FIG. 2, at step 118, the microprocessor 76 determines a change in pressure associated with the bladder 56 in the vehicle seat 20 over a vehicle life from an initial, empty vehicle seat pressure value.

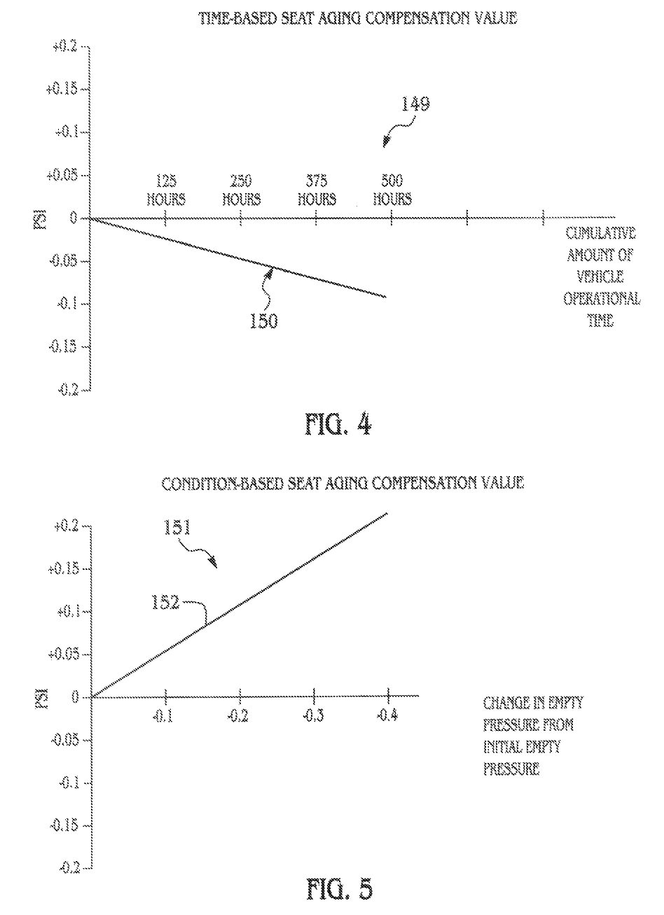

At step 120, the microprocessor 76 determines a condition-based seat aging compensation value based on the change in pressure associated with the bladder 56 over the vehicle life. Referring to FIG. 5, for example, the memory device 78 can store a second table having a plurality of values corresponding to the graph 151. The graph 151 has a y-axis corresponding to condition-based seat aging compensation values and an x-axis corresponding to associated changes in pressure from the initial empty vehicle seat pressure value. The curve 152 represents a plurality of condition-based seat aging compensation values. In particular, during operation, the microprocessor 76 can access the second table stored in the memory device 78 corresponding to the graph 151 to retrieve a condition-based seat aging compensation value associated with a change in pressure from an initial empty vehicle seat pressure value. For example, if the change in pressure determined by the microprocessor 76 is equal to −0.1 PSI, the microprocessor 76 could retrieve a condition-based seat aging compensation value of 0.05 PSI from the second table.

At step 122, the microprocessor 76 monitors the ignition system 75 to determine a first time interval value corresponding to a time interval that the vehicle 10 has been operated since activation of the ignition system 75.

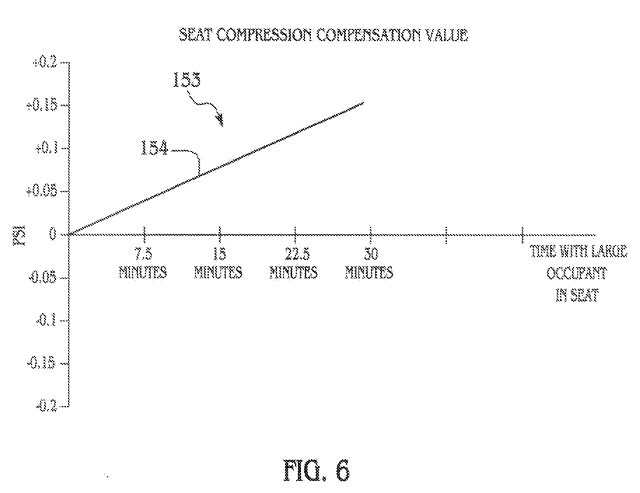

At step 124, the microprocessor 76 determines a seat compression compensation value based on the first time interval value. Referring to FIG. 6, for example, the memory device 78 can store a third table having a plurality of values corresponding to the graph 153. The graph 151 has a y-axis corresponding to compression compensation values, and an x-axis corresponding to associated time interval values of a vehicle being operated. The curve 154 represents a plurality of compression compensation values. In particular, during operation, the microprocessor 76 can access the third table stored in the memory device 78 corresponding to the graph 153 to retrieve a compression compensation value associated with a time interval value. For example, if the time interval value determined by the microprocessor 76 is equal to 7.5 minutes, the microprocessor 76 could retrieve a compression compensation value of 0.03 PSI from the third table.

At step 126, the microprocessor 76 determines a final pressure value indicative of the amount of pressure applied to the vehicle seat 20 based on the compensated pressure value, the time-based seat aging compensation value, the condition-based seat aging compensation value, and the seat compression compensation value. In particular, the final pressure value can be obtained by summing together the compensated pressure value, the time-based seat aging compensation value, the condition-based seat aging compensation value, and the seat compression compensation value.

At step 128, the microprocessor 76 stores the final pressure value in the memory device 78.

At step 130, the microprocessor 76 makes a determination as to whether the final pressure value is greater than a threshold value. It the value of step 130 equals “yes”, the method advances to step 132. Otherwise, the method advances to step 134.

At step 132, the microprocessor 76 sets a first seat occupant classification flag equal to a first predetermined value indicating the occupant of the vehicle seat 20 corresponds to a first classification of vehicle occupant, and stores the first seat occupant classification flag in the memory device 78. After step 132, the method is exited.

At step 134, the microprocessor 76 sets a second seat occupant classification flag equal to a second predetermined value indicating the occupant of the vehicle seat 20 corresponds to a second classification of vehicle occupant, and stores the second seat occupant classification flag in the memory device 78. After step 134, the method is exited.

The above-described method can be embodied in the form of computer-implemented software algorithms and apparatuses for practicing those processes. In an exemplary embodiment, the method is embodied in computer program code executed by one or more elements. The present method may be embodied in the form of computer program code containing instructions stored in tangible media, such as floppy diskettes, CD-ROMs, hard drives, flash memory, or any other computer-readable storage medium, wherein, when the computer program code is loaded into and executed by a microprocessor, the microprocessor becomes an apparatus for practicing the invention.

The inventive system and method for determining art amount of pressure applied by an occupant on a vehicle seat represents a substantial improvement over other systems and methods. In particular, the inventive system and method provide a technical effect of determining the amount of pressure applied by the occupant on the vehicle seat based on signals from a pressure transducer, a temperature sensor, and a belt tension sensor to more accurately determine the amount of pressure applied by the occupant on the vehicle seat.

While the invention has been described with reference to exemplary embodiments, it will be understood by those skilled in the art that various changes may be made and equivalent elements may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Further, the use of the terms a, an, etc. do not denote a limitation of quantity, but rather denote the presence of at least one of the referenced item.

What is claimed is:

1. A method for determining an amount of pressure applied by an occupant on a vehicle seat in a vehicle, comprising:
receiving a first signal from a pressure transducer in the vehicle seat at a microprocessor, the first signal being indicative of a pressure measured by the pressure transducer;
determining a pressure value based on the first signal, utilizing the microprocessor;
receiving a second signal from a temperature sensor at the microprocessor, the second signal indicating a temperature proximate the vehicle seat;
determining a temperature value based on the second signal, utilizing the microprocessor;
receiving a third signal from a belt tension sensor at the microprocessor, the third signal indicating an amount of tension on a seat belt associated with the vehicle seat;
determining a belt tension value based on the third signal, utilizing the microprocessor;
determining a compensated pressure value indicative of the amount of pressure applied to the vehicle seat based on the pressure value, the temperature value, and the belt tension value, utilizing the microprocessor; and
storing the compensated pressure value indicative of the amount of pressure applied to the vehicle seat in a memory device, utilizing the microprocessor.

2. The method of claim 1, further comprising:
monitoring an ignition system to determine a cumulative time interval value corresponding to a cumulative amount of time that the vehicle has been operated over a vehicle life, utilizing the microprocessor;
determining a time-based seat aging compensation value based on the cumulative time interval value, utilizing the microprocessor;
determining a final pressure value indicative of the amount of pressure applied to the vehicle seat based on the compensated pressure value and the time-based seat aging compensation value, utilizing the microprocessor; and
storing the final pressure value in the memory device, utilizing the microprocessor.

3. The method of claim 1, further comprising:
determining a change in pressure associated with a bladder in the vehicle seat over a vehicle life from an initial empty vehicle seat pressure value, utilizing the microprocessor;
determining a condition-based seat aging compensation value based on the change in pressure associated with the bladder;
determining a final pressure value indicative of the amount of pressure applied to the vehicle seat based on the compensated pressure value and the condition-based seat aging compensation value, utilizing the microprocessor; and
storing the final pressure value in the memory device, utilising the microprocessor.

4. The method of claim 1, further comprising:
monitoring an ignition system to determine a first time interval value corresponding to a time interval that the vehicle has been operated since activation of the ignition system, utilizing the microprocessor;
determining a seat compression compensation value based on the first time interval value, utilizing the microprocessor;
determining a final pressure value indicative of the amount of pressure applied to the vehicle seat based on the compensated pressure value and the seat compression compensation value, utilizing the microprocessor; and
storing the final pressure value in the memory device, utilizing the microprocessor.

5. The method of claim 1, wherein when the compensated pressure value is greater than a threshold value, the compensated pressure value is indicative of a first classification of vehicle occupant.

6. The method of claim 5, wherein when the compensated pressure value is less than or equal to the threshold value, the compensated pressure value is indicative of a second classification of vehicle occupant.

7. A system for determining an amount of pressure applied by an occupant on a vehicle seat in a vehicle, comprising:
a pressure transducer disposed in the vehicle seat, the pressure transducer configured to generate a first signal indicative of a pressure measured by the pressure transducer;
a temperature sensor disposed proximate the vehicle seat, the temperature sensor configured to generate a second signal indicating a temperature proximate the vehicle seat;
a belt tension sensor coupled to a seat belt associated with the vehicle seat, the belt tension sensor configured to generate a third signal indicating an amount of tension applied to a seat belt associated with the vehicle seat;
a microprocessor operably communicating with the pressure transducer and the temperature sensor and the belt tension sensor, the microprocessor configured to determine a pressure value based on the first signal, the microprocessor further configured to determine a temperature value based on the second signal, the microprocessor further configured to determine a belt tension value based on the third signal, the microprocessor further configured to determine a compensated pressure value indicative of the amount of pressure applied to the vehicle seat based on the pressure value, the temperature value, and the belt tension value, the microprocessor further configured to store the compensated pressure value indicative of the amount of pressure applied to the vehicle seat in a memory device.

8. The system of claim 7, wherein the microprocessor is further configured to monitor an ignition system to determine a cumulative time interval value corresponding to a cumulative amount of time that the vehicle has been operated over a vehicle life, the microprocessor further configured to determine a time-based seat aging compensation value based on the cumulative time interval value, the microprocessor further configured to determine a final pressure value indicative of the amount of pressure applied to the vehicle seat based on the compensated pressure value and the time-based seat aging compensation value, the microprocessor further configured to store the final pressure value in the memory device.

9. The system of claim 7, wherein the microprocessor is further configured to determine a change in pressure associated with a bladder in the vehicle seat over a vehicle life from an initial empty vehicle seat pressure value, the microprocessor further configured to determine a condition-based seat aging compensation value based on the change in pressure associated with the bladder, the microprocessor further configured to determine a final pressure value indicative of the amount of pressure applied to the vehicle seat based on the compensated pressure value and the condition-based seat aging compensation value, the microprocessor further configured to store the final pressure value in the memory device.

10. The system of claim 7, wherein the microprocessor is further configured to monitor an ignition system to determine a first time interval value corresponding to a time interval that the vehicle has been operated since activation of the ignition system, the microprocessor further configured to determine a seat compression compensation value based on the first time interval value, the microprocessor further configured to determine a final pressure value indicative of the amount of pressure applied to the vehicle seat based on the compensated pressure value and the seat compression compensation value, the microprocessor further configured to store the final pressure value in the memory device.

11. The system of claim 7, wherein when the compensated pressure value is greater than a threshold value, the microprocessor further configured to set a first flag equal to a first predetermined value indicating the occupant in the vehicle seat corresponds to a first classification of vehicle occupant, and to store the first flag in the memory device.

12. The system of claim 11, wherein when the compensated pressure value is less than or equal to the threshold value, the microprocessor is further configured to set a second flag equal to a second predetermined value indicating the occupant in the vehicle seat corresponds to a second classification of vehicle occupant, and to store the second flag in the memory device.
